(19) United States
(12) Patent Application Publication
(10) Pub. No.: US 2010/0236705 A1
(43) Pub. Date: Sep. 23, 2010

(54) Fluidic and Microdevice Apparatus and Methods For Bonding Components Thereof

(76) Inventor: Stephen Y. Chou, Princeton, NJ (US)

Correspondence Address: Polster, Lieder, Woodruff & Lucchesi, L.C., 12412 Powerscourt Dr. Suite 200, St. Louis, MO, 63131-3615, US

(21) Appl. No.: 11/464,942

(22) Filed: Aug. 16, 2006

Related U.S. Application Data
(63) Continuation-in-part of application No. 10/161,776, filed on Jun. 4, 2002, now Pat. No. 6,946,360.
Application No. 10/161,776 is a continuation-in-part of application No. 09/618,174, filed on Jul. 18, 2000, now Pat. No. 6,482,742.
(60) Provisional application No. 60/708,454, filed on Aug. 16, 2005.

(51) Int. Cl. B32B 37/10; B32B 3/30; B32B 38/00

(52) U.S. Cl. 156/273.7; 428/166; 156/292; 156/272.2

(57) ABSTRACT

An improved method of bonding involves using direct fluid pressure to press together the layers to be bonded. Advantageously one or more of the layers are sufficiently flexible to provide wide area contact under the fluid pressure. Fluid pressing can be accomplished by sealing an assembly of layers to be bonded and disposing the assembly in a pressurized chamber. It can also be accomplished by subjecting the assembly to jets of pressurized fluid. The result of this fluid pressing is reduction of voids and enhanced uniformity over an enlarged area.

### CROSS-REFERENCE TO RELATED APPLICATIONS

This application is related to, and claims priority from, U.S. Provisional Patent Application Ser. No. 60/708,454 filed on Aug. 16, 2005, which is herein incorporated by reference.

This application is a continuation-in-part of U.S. patent application Ser. No. 10/161,776 filed on Jun. 4, 2002 entitled “Fluid Pressure Bonding”, now U.S. Pat. No. 6,946,360 B2, which in turn is a continuation-in-part of U.S. patent application Ser. No. 09/618,174 filed on Jul. 18, 2000 and entitled “Fluid Pressure Imprint Lithography”, now U.S. Pat. No. 6,482,742. Each of the '776 and '174 applications together with the '360 and '742 patents, is incorporated herein by reference.

### STATEMENT REGARDING FEDERALLY SPONSORED RESEARCH

Not Applicable.

### BACKGROUND OF THE INVENTION

This invention relates to microdevices and fluidic devices, and, in particular, to the bonding selective areas and components of such a device, to the bonding of device surfaces with prefabricated patterns, and to associated methods for bonding wherein direct fluid pressure is used to press together a plurality of layers to be bonded. The processes of the present invention are particularly useful to provide void free, uniform bonding over an increased area by pressure alone or by the application of pressure and heat or electrical field.

Bonding is an important process in the fabrication of many industrial, electronic, biological and optical devices. Typically bonding is accompanied by pressure together with heat, electrical field or both heat and field. A plurality of layers to be bonded are stacked in a loose assembly and pressed together. They are then subjected to heat and/or an electric field under pressure. The heat and/or field may effectuate the formation of chemical bonds as in ionic bonding.

The usual method of pressing the layers together is to stack the layers in an assembly and dispose the assembly on respective rigid plates of a mechanical press. This technique, however, has serious limitations in bonding layers of large area or imperfect planarity. Even high precision mechanical presses present tolerance problems over large areas. Presses move on guide shafts through apertures, and the spacings between the shafts and their respective apertures permit undesirable relative translational and rotational shifts between the assembly and the plates. Thus mechanical presses present serious alignment problems in high precision bonding. Moreover, despite the most careful construction, the layers to be bonded are not perfectly planar. When assemblies of these layers are disposed on the rigid plates of a press, the deviations from planarity over large areas can result in variations in the bonding pressure and spacing. Accordingly, it is desirable to provide a method of bonding which avoids the limitations of mechanical presses.

Furthermore, the prior of art of bonding is for bond two pieces with the same size. There is a need to bond a material of a size smaller than the substrate to a selected location of the substrate and to bond a material with prefabricated patterns on its bonding surface to selected areas of the substrate.

### BRIEF SUMMARY OF THE INVENTION

An improved method of bonding involves using direct fluid pressure to press together the layers to be bonded. Advantageously one or more of the layers are sufficiently flexible to provide wide area contact under the fluid pressure. Fluid pressing can be accomplished by sealing an assembly of layers to be bonded and disposing the assembly in a pressurized chamber. It can also be accomplished by subjecting the assembly to jets of pressurized fluid. The result of this fluid pressing is reduction of voids and enhanced uniformity over an enlarged area. Several advantageous applications of the process are described.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a schematic flow diagram of the steps in an improved method of bonding;

FIG. 2 illustrates a typical assemblies for use in the improved method of FIG. 1;

FIG. 3 illustrates apparatus for practicing the method of FIG. 1;

FIGS. 4A-4E illustrate alternative sealing arrangements useful in the method of FIG. 1;

FIG. 5 shows alternative apparatus for practicing the method of FIG. 1;

FIGS. 6 and 7 illustrate use of the fluid pressure bonding process to cover patterned substrate surfaces;

FIG. 8 shows use of the process to seal selected regions of a substrate surface;

FIG. 9 illustrates bonding of adjacent patterned bonding surfaces;

FIGS. 10A and 10B show the combination of fluid pressure bonding and imprinting; and

FIG. 11 schematically diagrams methods for aligning layers to be bonded.

Corresponding reference numerals indicate corresponding parts throughout the several figures of the drawings. It is to be understood that the drawings are for illustrating the concepts set forth in the present disclosure and are not to scale.

### DESCRIPTION OF THE PREFERRED EMBODIMENT

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

This description is divided into two parts. Part I describes the fluid pressure bonding method, and Part II describes several advantageous applications of this bonding method for the fabrication of devices.

I. Fluid Pressure Bonding Method

In accordance with the invention, the problem of unwanted lateral movements of mechanical presses in bonding is ameliorated by using direct fluid pressure to press together the layers to be bonded. The inventive method applies fluid pressure over the assembly of layers to be bonded. Because the fluid pressure is isostatic, no significant unbalanced lateral forces are applied. Direct fluid pressure also includes fluid pressure transmitted to the assembly via a flexible membrane, as the membrane does not interfere with the transmission of isostatic pressure from the fluid. And streaming pressurized fluid from openings in a pressure vessel can also apply nearly isostatic direct fluid pressure on the plates or assembly.

It is contemplated that the invention will have important applications in the bonding of previously patterned layers. The layers can be aligned with respect to previous patterns using conventional alignment techniques, and be pressed by direct fluid pressure to minimize any relative lateral shifts. The consequence is improvement in the alignment of the patterns.

Referring to the drawings, FIG. 1 is a schematic flow diagram of an improved process for bonding using direct fluid pressure. An initial step shown in Block A, is to provide a plurality of layers to be bonded.

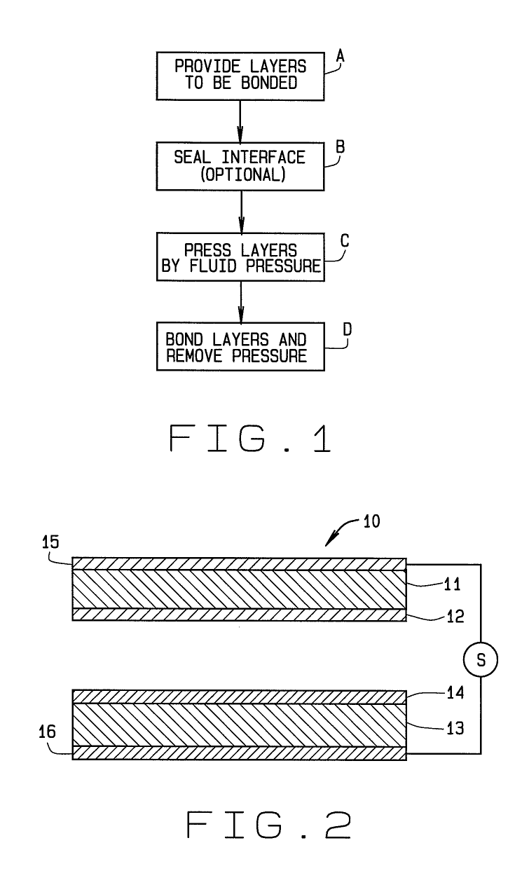

FIG. 2 illustrates a typical assembly 10 of layers 11, 13 to be bonded. The layer 11 is advantageously provided with an adherent coating 12 that will bond to layer 13 or to an adherent coating 14 on layer 13. For example, layers 11, 13 can be silicon wafers. Layer 11 can have an adherent coating 12 of aluminum and layer 13 can have an adherent outer surface 14 of silicon oxide. Under heat and pressure, adherent surface layers 12, 14 will adhere by metal-oxide bonding to bond layers 11, 13 together. In general, layers 11, 13 can be the same material or different materials. They can be plastic, glass, ceramic, or crystalline materials such as crystalline semiconductors.

Optionally, layers 11, 13 can be contacted by electrodes such as thin conductive layers 15 and 16, respectively, which can be disposed distally from the bonding interface. During the bonding step, the electrodes can be connected to a source S of voltage or current to facilitate bonding.

For highest uniformity and accuracy of placement, the layers to be bonded are advantageously made of the same material in order to minimize misalignment due to differential thermal expansion or contraction.

Preferably at least one of the layers 11, 13 is flexible so that, under the force of fluid pressure, the layers will conform despite deviations from planarity. Silicon substrates of thickness less than 2 mm exhibit such flexibility for typical pressures. Advantageously both layers are flexible.

The next step, shown in Block B, is to stack the layers together into an assembly to be bonded and to seal the interface between successive layers. If the layers include previously formed patterns to be bonded in registration, then the patterns should be carefully aligned in accordance with techniques well known in the art. The objective of the sealing is to permit external fluid pressure to press the layers together. The sealing can be effected in a variety of ways such as by providing a ring of fluid impermeable material, e.g. an elastomeric gasket, around the area to be bonded and peripherally clamping the assembly.

The third step (Block C) is to press the layers together by direct fluid pressure. One method for doing this is to dispose the assembly in a pressure vessel and to introduce pressurized fluid into the vessel. The advantage of fluid pressure is that it is isostatic. The resulting force uniformly pushes the layers together. Shear or rotational components are de minimus. Moreover if one or more of the layers is flexible rather than rigid, conformation between the layers is achieved regardless of unavoidable deviations from planarity. The result is an enhanced level of alignment and uniformity of spacing and bonding over an increased area of the film. The pressurized fluid can be gas or liquid. Pressurized air is convenient and typical pressures are in the range 1-1000 psi. The fluid can be heated, if desired, to assist in effectuating bonding.

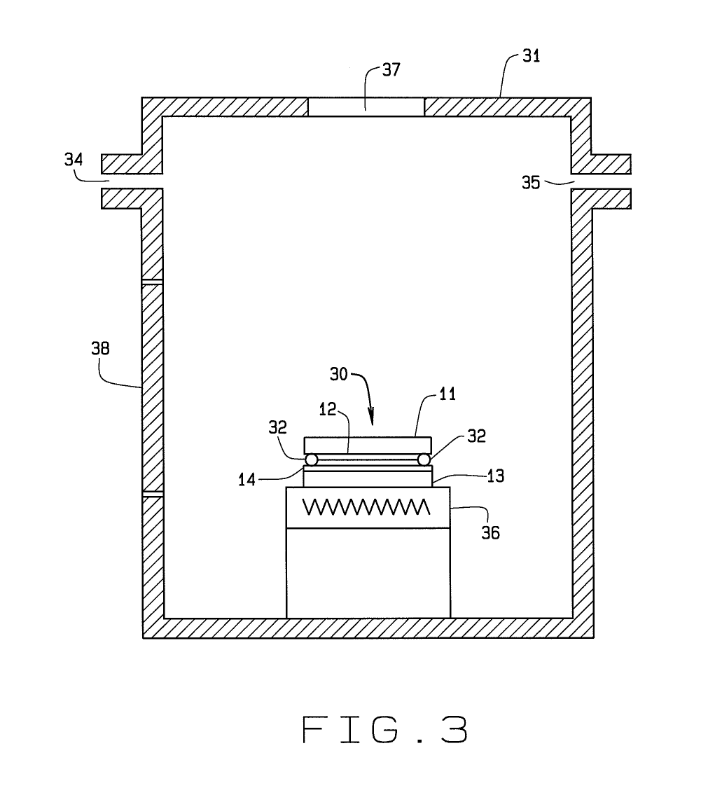

FIG. 3 illustrates a sealed assembly 30 disposed within a pressure vessel 31. The assembly 30 is sealed by a peripheral elastomeric gasket 32, extending around the area to be bonded. The periphery of the assembly can be lightly clamped by a clamp (not shown) to effectuate the seal. The vessel 31 preferably includes a valve-controlled inlet 34 for the introduction of pressurized fluid and a valve controlled outlet 35 for the exit of such fluid. The vessel 31 may optionally include a heater 36 for heating the layers and/or a transparent window 37 for introducing radiation to cure or cross link adhesives. A sealable door 38 can provide access to the interior of the vessel.

The next step shown in Block D, is to bond the layers of the assembly and to remove the bonded assembly from the pressure vessel. The precise process for bonding depends on the material of the layers. Many combinations of materials will bond with the application of pressure and heat. Others can bond under pressure by the application of an electric field or current between layers of the assembly. Yet others can be most easily bonded under pressure by applying both heat and an electric field or current. Heat can be applied in any one of a variety of known ways, including heating the pressurized fluid or applying infrared radiation. Voltage or current can be applied via a source S connected to electrodes 15, 16 as shown in FIG. 1. Voltages can range from 1 to 10,000 volts. Current densities can range from a nanoampere/cm.sup.2 to 10 amps/cm.sup.2. The source S can be AC or DC.

Alternatively, the layers can be bonded under pressure using adhesives. Radiation curable adhesives can be hardened under pressure by the application of UV radiation. Such radiation can be supplied through the window 37 of the pressure vessel. The layers can be made of transparent material to permit the radiation to reach the adhesive.

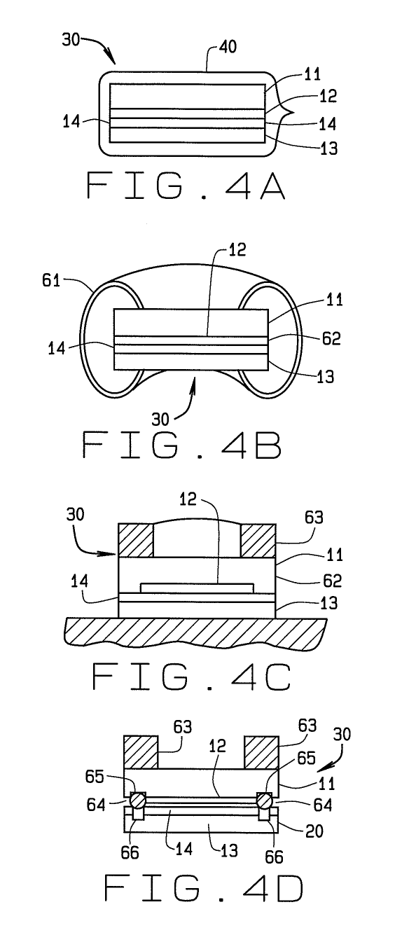

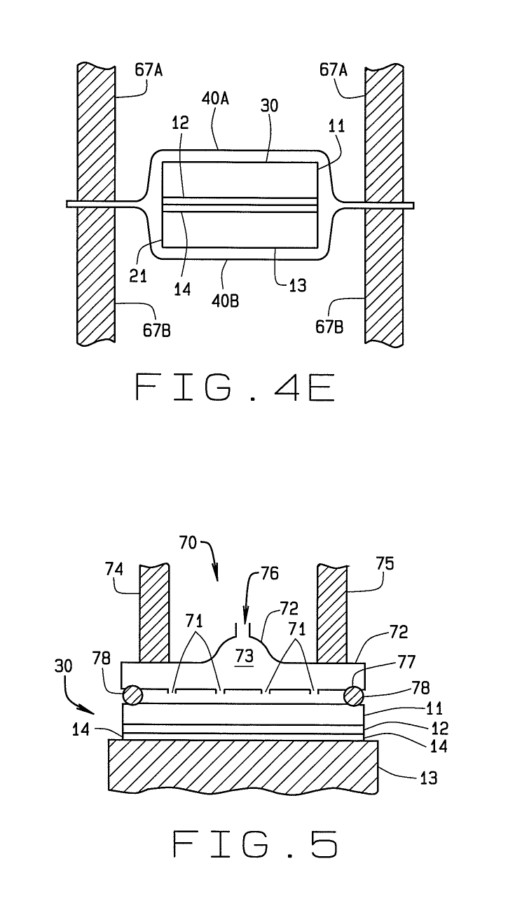

As mentioned above, there are a variety of ways of sealing the assembly of layers 30 so that pressurized fluid will press the layers together. FIGS. 4A-4D illustrate several of these ways.

FIG. 4A schematically illustrates an arrangement for sealing an assembly 30 by disposing the assembly within a sealed covering of flexible, fluid-impermable membrane 40 (e.g. a plastic bag). In this arrangement the regions between successive layers are sealed in relation to an external pressure vessel. Preferably the air is removed from the bag before applying pressure.

FIG. 4B shows an alternate sealing arrangement wherein the assembly 30 is sealed by a peripheral sealing clamp 61 which can be in the form of a hollow elastic torroid. Sealing can be assisted by providing one of the layers with a protruding region 62 extending around the region to be bonded. In use, the clamp and pressurized fluid will press the protruding region 62 into the layers, sealing the region to be bonded.

FIG. 4C illustrates a sealing arrangement in which the assembly 30 is sealed by applying a peripheral tube or weight 63 which lightly presses the periphery of the layers together. A peripheral protruding region 62 can assist sealing.

FIG. 4D shows an alternative sealing arrangement wherein the assembly 30 is sealed by a sealing O-ring 64 between successive layers. Preferably the O-ring seats within peripheral recesses 65, 66 in the layers. Light pressure from a peripheral tube or weight 63 can assist sealing.

FIG. 4E shows yet another sealing arrangement in which the assembly 30 is disposed between a pair of flexible impermeable membranes 40A and 40B and is enclosed within a pair of mating cylinders 67A, 67B. The mating cylinders sealingly press together the membranes around the periphery of the assembly. Application of fluid pressure to the interior of the cylinders presses the layers together.

Alternatively, two the cylinders could lightly seal against the layers, before pressurization. Yet further in the alternative, the assembly could rest upon a planar support and a single cylinder lightly seal against the layers.

FIG. 5 illustrates alternative pressing apparatus 70 where the assembly 30 is pressed together by streams of pressurized fluid. Here the assembly is disposed adjacent openings 71 in a hollow pressure cap 72 and the layers are pressed together by jets of pressurized fluid escaping through the openings 71. The cap 72 (analogous to vessel 31) has an internal chamber 73 for pressurized fluid. The regions between the layers are effectively sealed from the pressure vessel by the upper surface.

In operation, the assembly 30 is placed on a substrate holder 79. The cap 72 can be held in fixed position above the assembly 30, as by bars 74, 75. High pressure fluid, preferably gas, is pumped into chamber 73 through an inlet 76. The high pressure fluid within the chamber produces a fluid jet from each opening 71. These jets uniformly press the layers together.

Advantageously, the cap 72 can include a groove 77 along a perimeter of the face adjacent the assembly 30. The groove 77 can hold an O-ring 78 between the cap 72 and the assembly. The O-ring decreases fluid outflow between the cap 72 and the assembly 30, increasing the molding pressure and making it more uniform.

II. Applications of Fluid Pressure Bonding

Fluid pressure bonding as described herein has high potential for the fabrication of a variety of biological, chemical, electrical, optical, magnetic and mechanical devices. Because of its high precision and planarity, it is particularly useful in the fabrication of such devices having components with microscale features (minimum dimensions less than 10 micrometers) and nanoscale features (minimum dimensions less than 200 nanometers). Because of similarity of equipment and processing, it is highly compatible for use in conjunction with the fluid pressure imprint lithography such as described in U.S. Pat. No. 6,482,742 to Chou, incorporated herein by reference. In essence, fluid pressure imprint lithography can be used to form a microscale or nanoscale pattern on a substrate and fluid pressure bonding can be used to cover or embed part or all of the pattern or to form a more complex pattern by bonding over the patterned substrate a patterned cover. The patterns, for example, can be patterns of cavities, patterns of materials deposited in cavities, and patterns of doped semiconductors or doped other materials. These and other exemplary applications are described below.

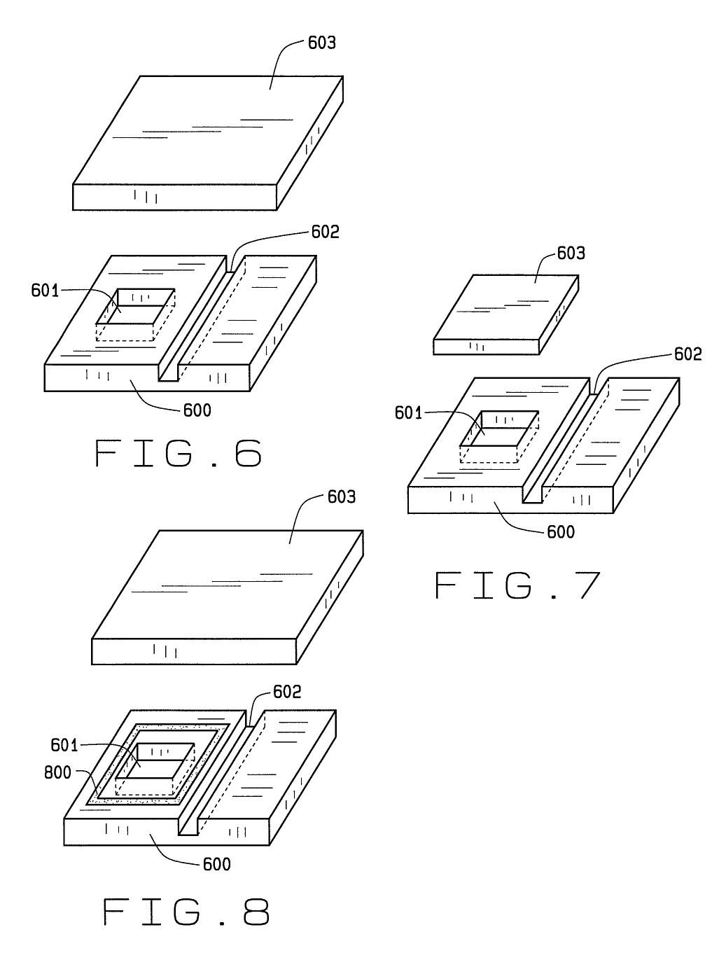

A variety of devices employ covered or embedded patterns such as cavities that may be empty, contain electronic, or optical materials, biological material, or magnetic materials, or guide the flow of fluids or macromolecules. As shown in FIG. 6, a substrate 600 can be patterned as by optical or imprint lithography into a pattern having one or more cavities such as well 601 and channel or trench 602. Then, empty or filled, these cavities or portions thereof can be covered by a plate 603 using fluid pressure bonding as described in Part I herein. The plate can cover the entire substrate, or as shown in FIG. 7, the plate 603 can have a lateral area less than that of the substrate 600 to seal only selected features of the substrate, e.g. to seal the well 601 but not the channel 602. The cavities can have the same or different shapes, sizes and geometries in all three dimensions. The thicknesses of the substrate and covers can be chosen for the particular application. Advantageously the substrate is patterned by fluid pressure imprint lithography and then covered by fluid pressure bonding. Bonding pressures depend on the strength and thickness of the layers to be bonded. They can be in the range 1000 to 20,000 psi or even beyond this range for some layers.

Sealing can be effected any of a variety of adhesives or coupling materials applied between the substrate and the cover. The adhesive/coupling material can be organic or inorganic, in an initial state of solid liquid or gas. It can be metal, semiconductor, dielectric, polymer or a combination. The adhesive/coupling material can bond by heating, cooling, radiation, pressure or chemical reaction. Depending on the specific use, the adhesive/coupling material can be applied by evaporation deposition, spin coating, misting, spraying, dipping, or forming a patterned layer.

One or more substrate patterns can be selectively sealed by applying or forming an adhesive or coupling layer on selected regions of the substrate. FIG. 8 illustrates the selective sealing of cavity 601 by the disposition of selective disposition of adhesive/coupling layer 800 on substrate regions peripherally around the cavity 601. When the cover 603 is applied by fluid pressure bonding, the cavity 601 is sealed but the channel 602 is not.

In fluid pressure bonding, pressure, heat and radiation can be applied in different sequence and even in multiple cycles to improve the bonding. For example, two layers can be bonded first by applying pressure and then by applying radiation (or heat). Another option is to first apply a lower pressure, then radiation and then a higher pressure. The initial pressure is preferably by fluid pressure bonding as described herein. Heating can be provided, for example, by a thermal heater, an RF heater or a radiation heater. Radiation can have a wavelength in the broad range from infra-red to x-ray.

In his work with laser-assisted direct imprint lithography, applicant has observed that a pulsed laser, such as an excimer laser, can quickly liquefy the surface of a solid material such as a semiconductor, metal, or ceramic. This phenomenon can be used in bonding.

Where one of the layers is transparent to the laser radiation while the other is opaque, the layers can be pressed together, and the laser radiation can be transmitted through the transparent layer to quickly liquefy the surface of the opaque layer. As an example, a quartz layer can be bonded to a silicon substrate by pressing together the quartz layer and the silicon and shining an excimer laser of 308 nm wavelength through the quartz. The laser beam will quickly melt a thin depth of the exposed silicon surface and bond the silicon to the quartz.

Fluid pressure bonding can be facilitated by the texturing or patterning the bonding surface or portions thereof. The texturing or patterning assists by increasing the total effective surface area. In addition, the patterning can be designed to facilitate mechanical alignment or to provide an optical or electrical indication of alignment.

Each of the two layers to be bonded can have bonding surfaces that have patterns or structures, and the adjacent patterned or structured, surfaces can be aligned prior to the application of pressure to produce a bonded structure of increased complexity or enhanced functionality.

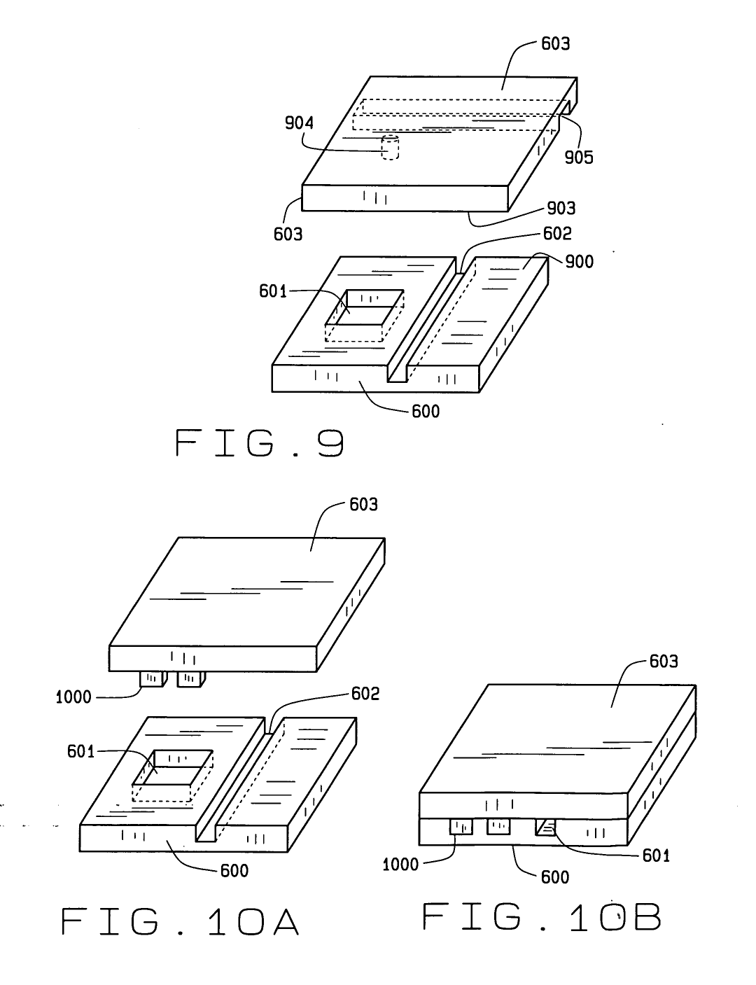

FIG. 9 illustrates this process with a substrate 600 having a cavity 601 and a channel cavity 602. Cover 603 has a bonding surface 903 including a pillar cavity 904 and a channel cavity 905. During bonding, the position and orientation of cover 603 can be aligned with the pattern on substrate 600 so that, for example, the channels 602 and 905 are perpendicular, and the pillar 904 is aligned with (communicates with) the well 601. In device embodiments, one or more of the channels can be filled with a material such as a conductor or a semiconductor to conduct electricity or to sense biological, chemical optical, or electrical activity.

As shown in FIGS. 10A and 10B, fluid pressure bonding can be combined with imprinting. In this example, the cover 603 is made of relatively hard material as compared with substrate 600 and includes a pattern of protrusions 1000 on the bonding surface. During the bonding process the protrusions 1000 can be driven into substrate 600 to embed therein a shown in FIG. 10B.

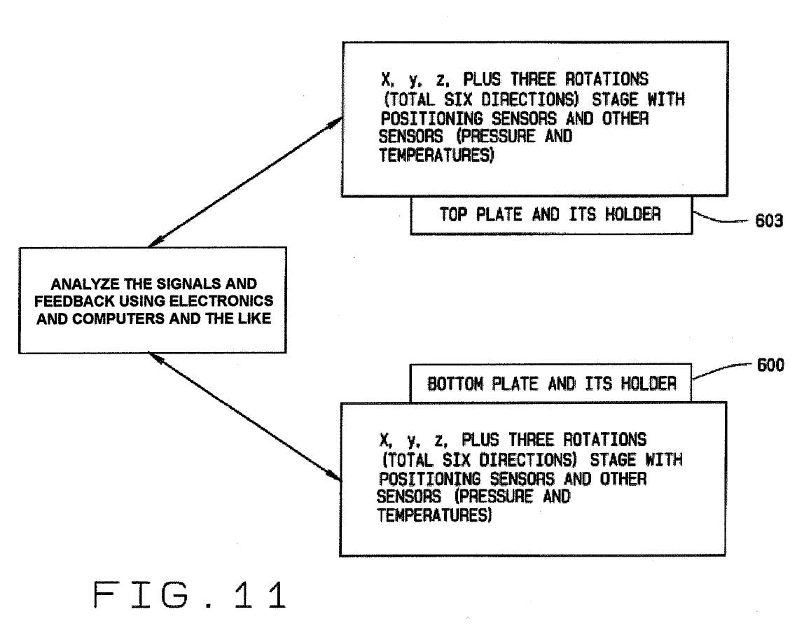

The alignment of between the bonding layers can be achieved using optical or electrical or mechanical alignment techniques as diagrammed in FIG. 11. For example, the alignment sensors and alignment marks may be optical detector and optical alignment marks, respectively, which generate a moire alignment pattern. Morie alignment techniques may then be employed to position the heating areas relative to the nanostructures to be repaired. Such techniques are described by Nomura et al., “A Moire Alignment Technique For Mix And Match Lithographic System”, Journal of Vaccuum Science & Technology B6(I), January/February 1988, pg. 394 and by Hara et al., “An Alignment Technique Using Defracted Moire Signals”, Journal of Vaccuum Science & Technology B7(6), November/December 1989, pg. 1977. As another example, alignment marks can be plates of a capacitor such that sensor detects the capacitance between marks.

A tool that performs alignment of bonding can include stages for different layers and for heating and radiation sources. Stages for both the top and the bottom layers can each have one or more of six dimensional movements (x,y,z plus three rotational directions) and sensors for the positions, rotations, pressure, temperature and alignments. The tool can include mechanisms for the alignment of the layers, sensors for machine operation, machine vision to monitor machine operation, and programmed machine intelligence. A controller can monitor all or part of the operational parameters, including electrical, optical, pneumatic and mechanical parameters. Control software can manage the feedback, analysis, intelligent decision-making, and the implementation of control.

While preceding applications have been described in the context of bonding two layers, it should be clear that the techniques described herein can be used to pattern and bond a multiplicity of successive layers to fabricate relatively complex biometric, mechanical, optical, electrical, electronic and magnetic devices. Components for such devices can be formed by imprinting appropriate patterns on successive layers, e.g. imprinting cavities and filling the cavities with appropriate structural, optical, electrical, electronic or magnetic materials. Or imprinting can be used to expose patterns on semiconductor layers for doping. Pillar cavities filled with appropriate materials can provide appropriate structures to transmit mechanical force, light, magnetism, electricity, or even heat from one layer to another. Multiple patterned layers thus interconnected can form increasingly complex devices such as macromolecular pathways, biological cell pathways, capacitors, inductors, transistors, lasers and transformers by appropriate choice of patterned layers and pillar connectors. Moreover, by using fluid pressure imprint lithography to make the patterns and by using fluid pressure bonding to precisely align and bond successive patterned layers, such complex multilayer devices can be fabricated with lateral dimensions in the microscale and even nanoscale ranges.

It will be recognized that the fluidic and microdevices of the present invention may be assembly and bonding with pressure applied from sources other than direct fluid pressure. For example, a fluidic or microdevice of the present invention may be bonded during application of pressure in a parallel press with a solid pressing plate or with a thin layer of elastic material on the surface of a hard solid state plate. Alternatively, a hard press plate may be utilized to apply pressure to one side of the fluidic or microdevice during bonding, while a fluidic press is utilized to apply a direct fluid pressure to an opposite side.

As various changes could be made in the above constructions without departing from the scope of the disclosure, it is intended that all matter contained in the above description or shown in the accompanying drawings shall be interpreted as illustrative and not in a limiting sense.

1. A bonded multilayer microdevice, comprising:
a substrate having a pattern disposed on an exposed surface, said pattern including at least one feature having a minimum dimension of less than 10 micrometers; and
a covering layer having an area smaller than the substrate bonded to said exposed surface over at least a portion of said pattern.

2. The bonded multilayer microdevice of claim 1 wherein said pattern is a nanoscale pattern having minimum dimensions of less than 200 nanometers.

3. The bonded multilayer microdevice of claim 1 wherein said selected material is chosen from a set of materials including electronic material, optical materials, biological material, and magnetic material.

4. The bonded multilayer microdevice of claim 1 wherein said pattern includes at least one doping material disposed on said exposed surface.

5. The bonded multilayer microdevice of claim 4 wherein said at least one doping material is a semiconductor.

6. The bonded multilayer microdevice of claim 1 wherein said pattern defines at least one fluidic pathway on said exposed surface configured to guide a flow of material.

7. The bonded multilayer microdevice of claim 1 wherein said covering layer includes a second pattern facing said exposed surface.

8. The bonded multilayer microdevice of claim 7 wherein said second pattern is a microscale pattern having minimum feature dimensions of less than 10 micrometers.

9. The bonded multilayer microdevice of claim 7 wherein said second pattern is a nanoscale pattern having minimum feature dimensions of less than 200 nanometers.

10. The bonded multilayer microdevice of claim 7 wherein said second pattern includes at least one cavity disposed in said covering layer.

11. The bonded multilayer microdevice of claim 10 wherein a selected material is deposited within said at least one cavity.

12. The bonded multilayer microdevice of claim 11 wherein said selected material is chosen from a set of materials including electronic material, optical material, and magnetic material.

13. The bonded multilayer microdevice of claim 7 wherein said second pattern includes at least one doping material disposed on said covering layer.

14. The bonded multilayer microdevice of claim 13 wherein said at least one doping material is a semiconductor.

15. The bonded multilayer microdevice of claim 7 wherein said second pattern defines at least one fluidic pathway on said exposed surface configured to guide a flow of material.

16. The bonded multilayer microdevice of claim 7 wherein said second pattern on said covering layer is aligned in an operative relationship with said pattern on said exposed surface.

17. The bonded multilayer microdevice of claim 1 further include an adhesive disposed between said substrate and said covering layer.

18. The bonded multilayer microdevice of claim 17 wherein said adhesive is contiguous about at least a portion of said pattern.

19. The bonded multilayer microdevice of claim 17 wherein said adhesive layer seals at least a portion of said pattern between said substrate and said covering layer.

20. The bonded multilayer microdevice of claim 1 wherein said pattern includes at least one channel disposed within said exposed surface of said substrate.

21. The bonded multilayer microdevice of claim 1 wherein said covering layer includes a plurality of protrusions, said protrusions embedded within said substrate.

22. The bonded multilayer microdevice of claim 1 wherein said covering layer is transparent to radiation at a selected wavelength, and said substrate is opaque to radiation at said selected wavelength.

23. The bonded multilayer microdevice of claim 22 wherein said substrate is composed of silicon, and wherein said covering layer is composed of quartz.

24. The bonded multilayer microdevice of claim 22 wherein said selected wavelength is 308 nm.

25. The bonded multilayer microdevice of claim 1 wherein said substrate defines a first surface area; said cover plate defines a second surface area; and wherein said first and second surface areas have different dimensions.

26. A method for assembling a multilayer microdevice, comprising:
providing a substrate having a pattern disposed on an exposed surface;
disposing with precise registration accuracy, a covering layer over at least a portion of said pattern on said exposed surface;
sealing the interface between the covering layer and the substrate;
pressing said covering layer and said exposed surface of said substrate together with direct fluid pressure, said direct fluid pressure further applied uniformly about a exterior periphery of said sealed interface to minimize changes in said registration between said covering layer and said pattern resulting from lateral movement there between during said pressing; and
bonding said covering layer to said exposed surface.

27. The method of claim 26 wherein said substrate is opaque to radiation at a selected wavelength, wherein said covering layer is transparent to radiation at said selected wavelength, and wherein said bonding step includes transmitting radiation at said selected wavelength through said covering layer to liquefy a portion of said exposed surface of said substrate, said covering layer bonding to said substrate upon re-solidification of said liquefied portion.

28. The method of claim 27 wherein said selected wavelength is 308 nm.

29. The method of claim 27 wherein said substrate is silicon, and wherein said covering layer is quartz.

30. The method of claim 26 further including the step of disposing a material within at least a portion of said pattern prior to disposing said covering layer over said pattern.

31. The method of claim 26 wherein said covering layer includes a second pattern facing said exposed surface; and
further including the step of aligning said first and second patterns prior to bonding said covering layer to said exposed surface.

32. The method of claim 26 further including the step of applying an adhesive between said covering layer and said exposed surface, said adhesive facilitating said bonding of said contact layer and said exposed surface.

33. The method of claim 32 wherein said adhesive is continuous about a peripheral edge of at least a portion of said pattern; and wherein said adhesive seals said portion of said pattern during bonding.

34. The method of claim 26 wherein at least a portion of said pattern defines at least one fluidic pathway across said exposed surface.

35. The method of claim 26 wherein at least a portion of said pattern defines at least one cavity in said exposed surface.

36. The method of claim 26 wherein said covering layer includes at least one protrusion; and wherein said step of pressing includes embedding said at least one protrusion within said substrate.

37. A bonded multilayer microdevice, comprising:
a substrate having a first pattern disposed on an exposed surface, said first pattern including at least one feature having a minimum dimension of less than 10 micrometers, said feature selected from a set of features including recessed regions, cavities, channels, fluidic pathways, and recessed regions which are at least partially filled with a selected material;
a covering layer bonded to said exposed surface over at least a portion of said pattern, said covering layer having a second pattern disposed on an exposed surface, said second pattern including at least one feature having a minimum dimension of less than 10 micrometers, said feature selected from a set of features including recessed regions, cavities, channels, fluidic pathways, and recessed regions which are at least partially filled with a selected material; and
wherein at least one feature of said first pattern and at least one feature of said second pattern are aligned in an operative relationship.

38. The bonded multilayer microdevice of claim 37 further including an adhesive material disposed between said substrate and said covering layer, said adhesive material bonding said covering layer to said substrate.

39. The bonded multilayer microdevice of claim 38 wherein said adhesive material forms a continuous seal about a peripheral edge of at least one feature of either said first pattern or said second pattern.

40. A method for bonding a plurality of layers comprising the steps of:
providing the layers;
stacking the layers together in a precise aligned registration into an assembly to be bonded;
sealing the interface between the successive layers;
pressing the layers together by direct fluid pressure, said direct fluid pressure further applied uniformly about a periphery of said sealed interface to minimize changes in said aligned registration of said stacked layers in said assembly resulting from lateral movement there between during said pressing;
bonding the layers of the assembly together; and
wherein at least one of the layers includes a microscale pattern having at least one element with a minimum dimension of less than 10 micrometers, said element selected from a group consisting of unfilled recessed regions, recessed regions at least partially filled with a selected material, projection regions, regions of doped semiconductor, regions of magnetic material, regions of conductive material, regions of insulating material, and regions of semiconductor material.

41. The method of claim 40 wherein said element comprises recessed regions at least partially filled with said selected material; and wherein said selected material is chosen from a set of materials including electronic material, optical materials, biological material, and magnetic material.

42. (canceled)

43. The method of claim 40 wherein the layers are pressed together by disposing the assembly in a pressure vessel and introducing pressurized fluid into the vessel.

44. The method of claim 43 wherein said pressurized fluid is heated.

45. The method of claim 40 wherein the bonding is at least partially effected by heating the pressed layers of the assembly.

46. The method of claim 40 wherein the bonding is at least partially effected by applying an electrical field between the layers of the assembly.

47. The method of claim 40 wherein the bonding is at least partially effected by applying an electrical current between the layers of the assembly.

48. The method of claim 40 wherein the layers are pressed together by at least one stream of pressurized fluid.

49. The method of claim 48 wherein said at least on stream of pressurized fluid comprises a plurality of jets of pressurized fluid.

50. (canceled)

51. (canceled)

52. The method of claim 50 wherein the sealing is effected by providing a ring of fluid impermeable material around the area to be bonded.

53. The method of claim 52 further comprising clamping the assembly peripherally around the area to be bonded.

54. (canceled)

55. (canceled)

56. (canceled)

57. The method of claim 40 wherein the bonding is at least partially effected by the application of ultraviolet radiation to a radiation curable adhesive.

58. The method of claim 40 wherein the interface is sealed by disposing the assembly within a sealed covering of a flexible, fluid-impermeable membrane.

59. The method of claim 50 wherein the interface is sealed by clamping the periphery of the assembly with a peripheral sealing clamp.

60. The method of claim 59 wherein the periphery is clamped by a hollow elastic torroid.

61. The method of claim 59 wherein the periphery is clamped by pressure from a peripheral tube.

62. The method of claim 50 wherein the interface is sealed by disposing an O-ring between successive layers and applying pressure between the successive layers.

63. (canceled)

64. (canceled)

65. (canceled)

66. (canceled)

67. (canceled)
